(19) United States
(12) Patent Application Publication
(10) Pub. No.: US 2005/0149353 A1
(43) Pub. Date: Jul. 7, 2005

(54) Selecting apparel for surgical procedures

(76) Inventors: Ladd Nichols, Marietta, GA (US); Robert S. Hoctor, Newton, CT (US); Henry Griesbach, Clarkston, GA (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/748,714

(22) Filed: Dec. 30, 2003

(51) Int. Cl. G06F 17/60

(52) U.S. Cl. 705/2

(57) ABSTRACT

The present invention relates to a method of selecting apparel products for surgical procedures. The method includes executing program code in a data processing system in order to determine surgical procedures that are associated with a type of apparel; selecting one of the surgical procedures; and executing program code in the data processing system in order to determine apparel products that are associated with the selected surgical procedure. The present invention also relates to a data processing system that includes a computer readable storage medium, and program code stored on the computer readable storage medium, wherein executing the program code includes determining surgical procedures that are associated with a type of apparel entered by a user, accepting one of the surgical procedures as selected by the user, and determining apparel products that are associated with the selected surgical procedure.

### BACKGROUND

There are many factors to consider when selecting apparel for surgical procedures. One example factor is that many products may be suited for some surgical procedures and not others. In addition, some of the apparel may need to meet one or sets of guidelines, such as the guidelines promulgated by the Occupational Health and Safety Administration (OSHA) and Association of periOperative Registered Nurses (AORN). The apparel may also need to meet certain hospital and/or operating room specific guidelines. If the surgical procedure is part of a clinical study, the apparel may also need to meet one or more guidelines that are specified in the particular clinical study.

It may also be desirable that the apparel for some surgical procedures include certain features (e.g., providing a fluid barrier). In addition, an individual may not be able to readily recall every beneficial feature that might be included in each type of apparel as the individual searches for apparel.

The apparel may also need to meet one or more special requirements of the particular individual that will be wearing the apparel during a surgical procedure. As an example, the size of the apparel may be important. In addition, the individual may have allergies to certain of materials (e.g., latex) such that the individual should not wear apparel made from latex. There may also be restrictions associated with using some types of apparel such that the apparel should not be used for certain surgical procedures.

One of the ways that apparel has been traditionally selected for a surgical procedure is through the use of catalogs. One drawback with catalogs is that they can become outdated. In addition, most catalogs are not organized to allow an efficient review of all of the available apparel products for a surgical procedure.

### SUMMARY OF THE INVENTION

There is a need for methods and data processing systems that allow individuals to select apparel products for surgical procedures without requiring the individual to sort through large amounts of information. The method and data processing system of the present invention assist in the selection of apparel products for surgical procedures by allowing individuals to automatically organize the apparel products based on criteria established by the individual.

The present invention relates to a method of selecting apparel products for surgical procedures. The method includes executing program code in a data processing system in order to determine surgical procedures that are associated with a type of apparel; selecting one of the surgical procedures; and executing program code in the data processing system in order to determine apparel products that are associated with the selected surgical procedure.

In another form, the method includes executing program code in a data processing system in order to determine guidelines that are associated with a type of apparel; selecting one of the guidelines; and executing program code in the data processing system in order to determine apparel products that are associated with the selected guideline.

In yet another form, the method includes executing program code in the data processing system in order to determine customized items that are associated with a type of apparel; selecting one of the customized items; and executing program code in the data processing system in order to determine apparel products that are associated with the selected customized item.

In still another form, the method includes entering a surgical procedure into a data processing system; and executing program code in a data processing system in order to determine apparel products that are associated with a surgical procedure; and displaying the apparel products to a user.

The present invention also relates to a data processing system. The data processing system includes a computer readable storage medium, and program code stored on the computer readable storage medium, wherein executing the program code includes determining surgical procedures that are associated with a type of apparel entered by a user, accepting one of the surgical procedures as selected by the user, and determining apparel products that are associated with the selected surgical procedure.

In another form, the data processing system includes a computer readable storage medium, and program code stored on the computer readable storage medium, wherein executing the program code includes determining guidelines that are associated with a type of apparel entered by a user, accepting one of the guidelines as selected by the user, and determining apparel products that are associated with the selected guideline.

In still another form, the data processing system includes a computer readable storage medium, and program code stored on the computer readable storage medium, wherein executing the program code includes determining customized items that are associated with a type of apparel entered by a user, accepting one of the customized items as selected by the user, and determining apparel products that are associated with the selected customized item.

In yet another form, the data processing system includes a computer readable storage medium, and program code stored on the computer readable storage medium, wherein executing the program code includes accepting a surgical procedure entered by a user, determining types of apparel that are associated with the surgical procedure entered by the user, accepting one type of apparel as selected by the user, and determining apparel products that are associated with the selected type of apparel.

The purposes and features of the present invention will be set forth in the description that follows. Additional features of the invention will be realized and attained by the product and processes particularly pointed out in the written description and claims hereof, as well as from the appended drawings.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention.

### BRIEF DESCRIPTION OF THE DRAWINGS

The present invention will be more fully understood, and further features will become apparent, when reference is made to the following detailed description and the accompanying drawings. The drawings are merely representative and are not intended to limit the scope of the claims. Like parts depicted in the drawings are referred to by the same reference numerals.

FIG. 1 is a block diagram of a data processing system which executes an apparel product for surgical procedures selection program in accordance with the present invention.

FIG. 2 illustrates the relationship between the databases that are included in the apparel products for surgical procedures selection program.

FIGS. 3-6 illustrate example constructions of the databases shown in FIG. 2.

FIG. 7 is a flow diagram illustrating an example of the execution steps that may be included in the apparel products for surgical procedures selection program.

FIG. 8 is a flow diagram illustrating another example of the execution steps that may be included in the apparel products for surgical procedures selection program.

### DETAILED DESCRIPTION

In the following detailed description, reference is made to the accompanying drawings, which show specific embodiments in which the invention may be practiced. These embodiments are described in sufficient detail to enable those skilled in the art to practice the invention. It is to be understood that other embodiments may be utilized and structural changes made, such that the following detailed description is not to be taken in a limiting sense.

The present invention relates to a method and data processing system that allow a user to find apparel products that are used in surgical procedures. The method and data processing system allow a user to effectively search for such apparel products over the internet or any another type of data processing system.

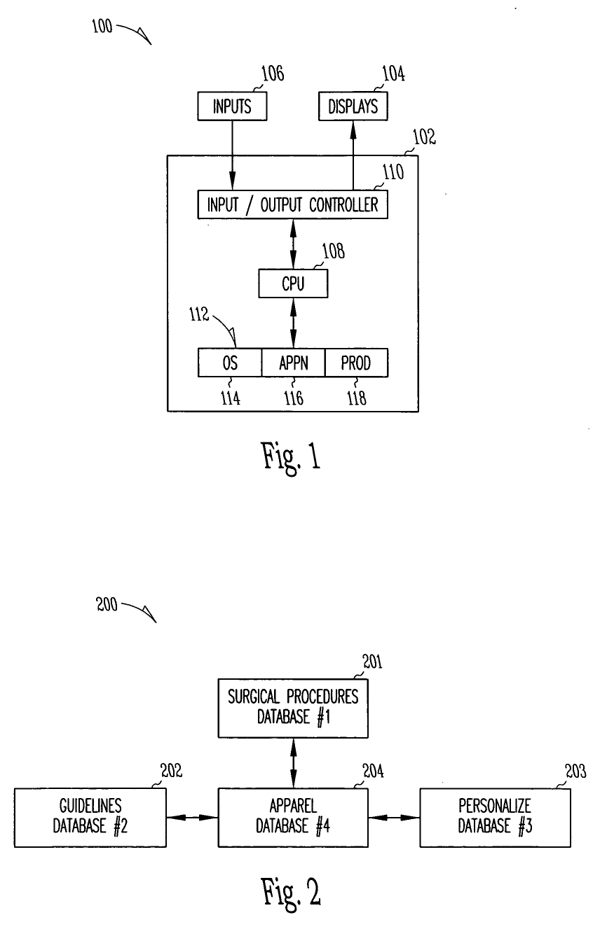

One possible operating environment of the present invention is a data processing system, such as data processing system 100 shown in FIG. 1. The data processing system 100 may be a personal computer or workstation which includes a processor 102, one or more display terminals 104, and one or more input devices 106. The display terminals 104 may include a monitor having a viewing screen, a printer, and/or the like. The input devices 106 may include a mouse, a keyboard, and/or similar devices.

The processor 102 includes a central processing unit (CPU) 108 which communicates with the display terminals 104 and the input devices 106 through an input/output controller 110, and which processes program code stored in a memory 112. The program code stored in the memory 112 includes, at least in part, an operating system 114, various application programs 116, and an apparel product selection program 118. The application programs 116 may include word processing programs, spread sheet programs, and the like. The apparel product selection program 118 is executed by the processor 102 in order to perform the functions of the present invention.

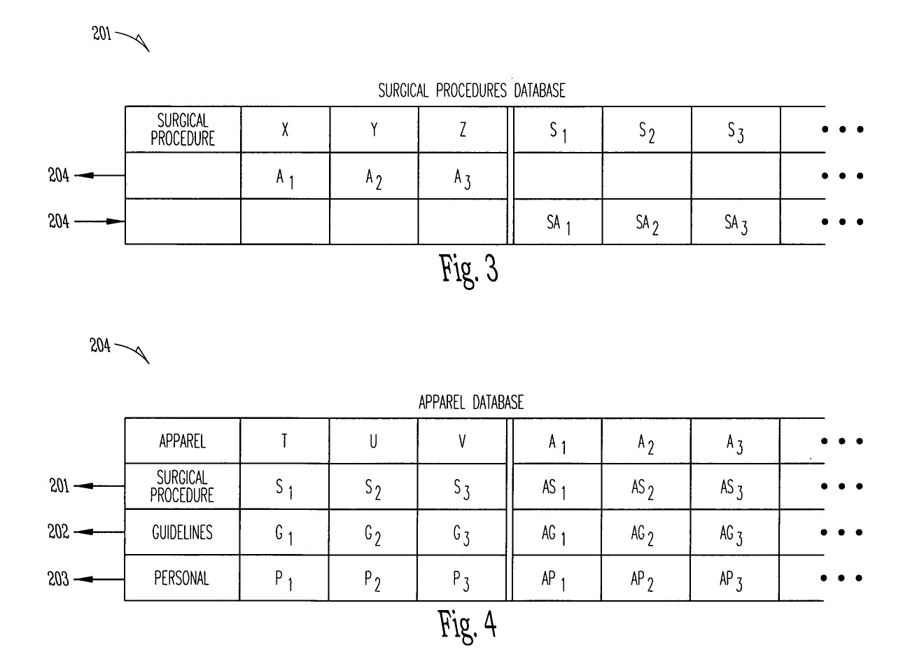

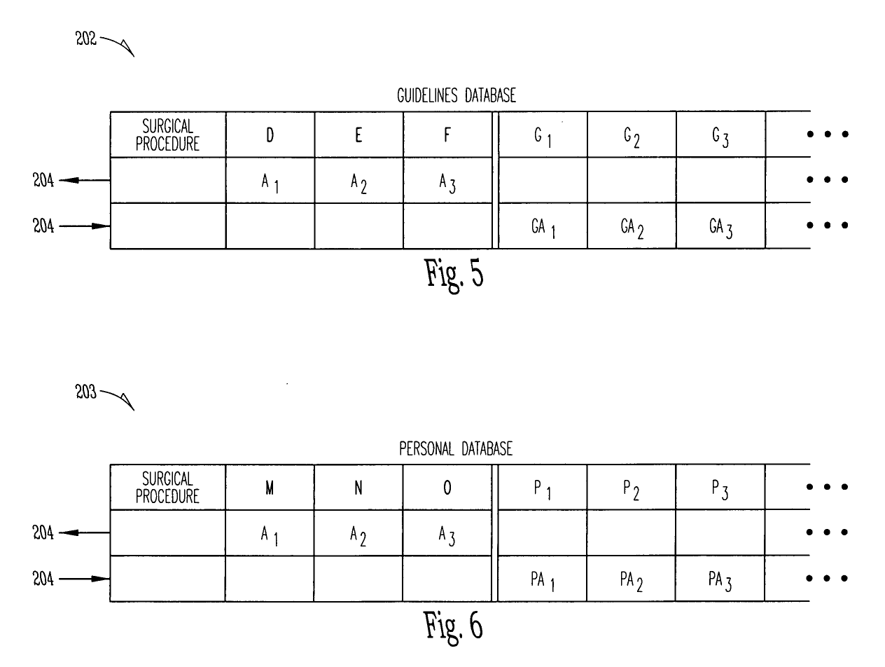

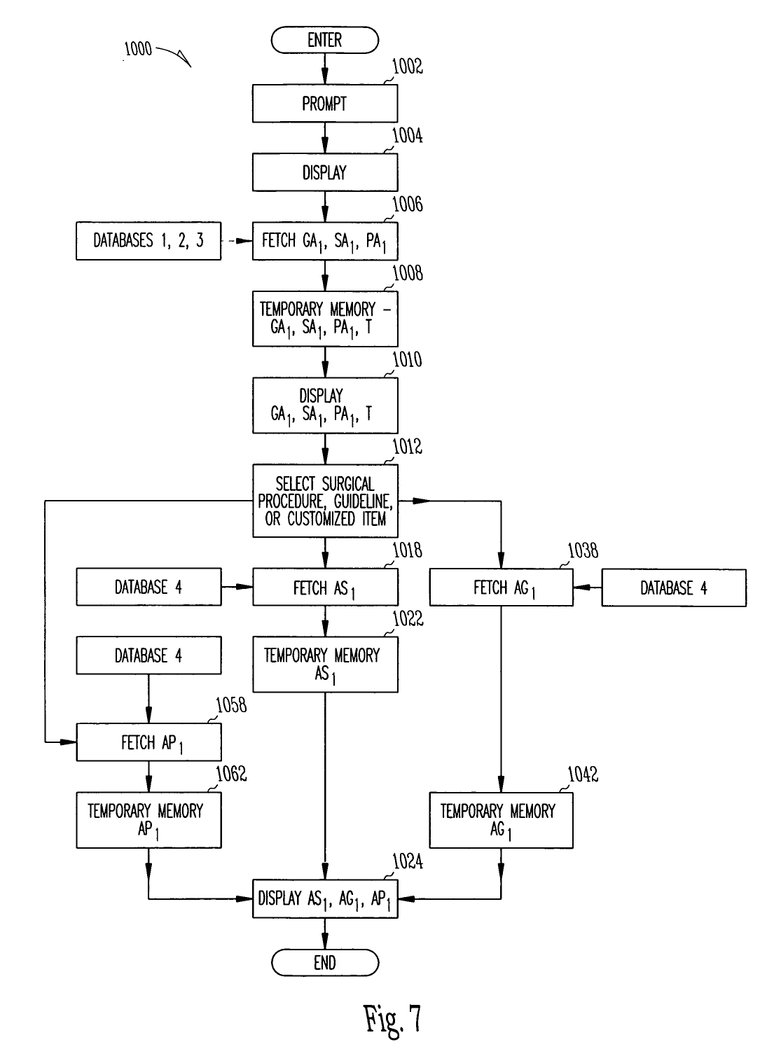

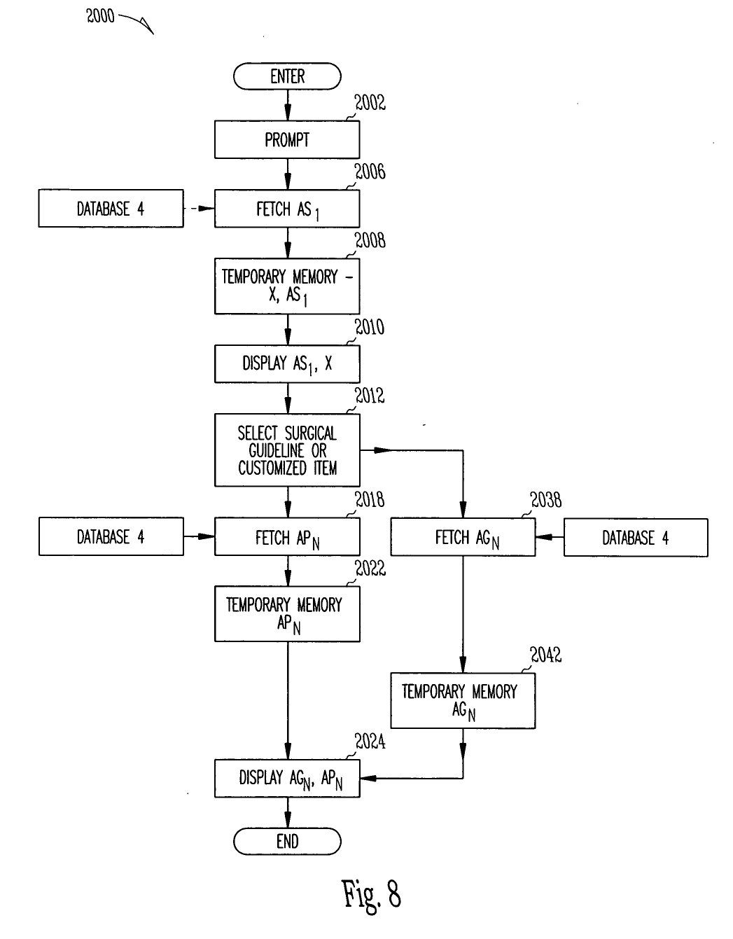

In one example form, the apparel product selection program 118 has a database component 200, which is illustrated in FIGS. 3-6, and an apparel selection component 1000, 2000, which are illustrated in FIGS. 7-8. FIG. 2 shows that the database component 200 of the apparel product selection program 118 is comprised of four databases. These databases include a Surgical Procedures Database 201, a Guidelines Database 202, a Personal Database 203, and an Apparel Database 204.

FIG. 2 also illustrates the interrelationship between the databases 201-204. This interrelationship is established by pointers which are contained in the database component 200 and which point from one database to another database.

It should be noted that each database in the database component 200 of the apparel product selection program 118 may contain pointers to one or more of the other databases in the database component 200 of the apparel product selection program 118. Whether a database 201-204 contains a pointer to another database depends on the interrelationship between each of the databases 201-204.

As examples, the Surgical Procedures Database 201 has pointers which point into the Apparel Database 204. Similarly, the Guidelines Database 202 contains pointers which point into the Apparel Database 204. In addition, the Personal Database 203 contains pointers which point into the Apparel Database 204. Finally, the Apparel Database 204 has pointers which point into each of the other databases 201-203.

Examples of the databases 201-204 are illustrated in FIGS. 3-6. These examples are illustrative of the type of data which should be contained in the databases 201-204 in order to facilitate operation of the present invention. It should be understood, however, that these examples are not exhaustive of the type of data which may be contained within each of the databases 201-204.

Accordingly, an example of the Surgical Procedures Database 201 is illustrated in FIG. 3. This example of the Surgical Procedures Database 201 includes data for three example surgical procedures, which are designated, for purposes of this example, as X, Y, and Z. For each such surgical procedure, the Surgical Procedures Database 201 includes (i) Apparel pointers A₁, A₂, A₃ . . . Aₙ₋₁, Aₙ, Aₙ₊₁ . . . which point into the Apparel Database 204. The Apparel pointers A₁, A₂, A₃, . . . Aₙ₋₁, Aₙ, Aₙ₊₁ . . . point into the Apparel Database 204 in order to designate the types of apparel which are associated with the surgical procedures listed in the Surgical Procedures Database 201.

The Surgical Procedures Database 201 also stores a listing of the surgical procedures SA₁, SA₂, SA₃ . . . which are associated with the apparel contained in Apparel Database 204. These surgical procedures SA₁, SA₂, SA₃ . . . are stored in the Surgical Procedures Database 201 in accordance with the surgical procedure pointers S₁, S₂, S₃ . . . Sₙ₋₁, Sₙ, Sₙ₊₁ . . . contained in the Apparel Database 204.

It should be noted that any type of surgical procedure may be contained within the Surgical Procedures Database 201. In addition, the surgical procedures may be stored in the Surgical Procedures Database 201 at multiple surgical levels. As an example, leg surgery, knee surgery and arthroscopic knee surgery may all be stored in the Surgical Procedures Database 201 singularly, or in some combination. Some other example surgical procedures include cesarean section, laparoscopic appendectomy, shoulder arthroscopy, hip-replacement, heart by-bypass, cardiac catheterization (or coronary angiogram), coronary artery bypass graft (CABG), ophthalmic and various excisions (among other procedures).

It should be noted that other procedures may be included in the surgical procedures database 201. Some examples include other invasion percutaneous medical procedures and wound cleansing and/or debridement procedures

In some forms, the Surgical Procedures Database 201 may also store one or more features that are desirable when performing certain types of surgery. The features may be stored in addition to, or instead of, surgical procedures depending on the design of the database component 200. As examples, the Surgical Procedures Database 201 may store information relating to whether certain apparel provides features such as a fluid resistance, fluid impermeability, fluid filtration (such as air), body coverage, inflammability, lint or particle minimization and mobility (among other features). In some forms, the features of certain apparel may be part of a separate database.

An example of the Apparel Database 204 is illustrated in FIG. 4. This example of the Apparel Database 204 includes data for three example types of apparel which are designated, for purposes of this example, as apparel T, U and V. For each type of apparel, the Apparel Database 204 includes (i) Surgical Procedures pointers S₁, S₂, S₃, . . . Sₙ₋₁, Sₙ, Sₙ₊₁ . . . which point into the Surgical Procedures Database 201, (ii) Guidelines pointers G₁, G₂, G₃, . . . Gₙ₋₁, Gₙ, Gₙ₊₁ . . . which point into the Guidelines Database 202, and (iii) Personal pointers P₁, P₂, . . . Pₙ₋₁, Pₙ, Pₙ₊₁, . . . which point into the Personal Database 203.

The Surgical Procedures pointers S₁, S₂, S₃ . . . Sₙ₋₁, Sₙ, Sₙ₊₁ . . . point into the Surgical Procedures Database 201 in order to designate the types of surgical procedures which are associated with the apparel listed in the Apparel Database 204. Similarly, Guidelines pointers G₁, G₂, G₃ . . . Gₙ₋₁, Gₙ, Gₙ₊₁ . . . point into the Guidelines Database 202 in order to designate the guidelines that may be required for the apparel listed in the Apparel Database 204. In addition, Personal pointers P₁, P₂, . . . Pₙ₋₁, Pₙ, Pₙ₊₁, . . . point into the Personal Database 203 in order to designate the how the apparel listed in the Apparel Database 204 may be personalized (i.e., customized) to a user.

The Apparel Database 204 also stores a listing of the apparel AS₁, AS₂, AS₃ . . . which is associated with the surgical procedures contained in Surgical Procedures Database 201. The apparel AS₁, AS₂, AS₃ . . . are stored in the Apparel Database 204 in accordance with the apparel pointers A₁, A₂, A₃, . . . Aₙ₋₁, Aₙ, Aₙ₊₁ . . . contained in the Surgical Procedures Database 201 (FIG. 3).

The Apparel Database 204 also stores a listing of the apparel AG₁, AG₂, AG₃ . . . which is associated with the guidelines contained in Guidelines Database 202. The apparel AG₁, AG₂, AG₃ . . . are stored in the Apparel Database 204 in accordance with the apparel pointers A₁, A₂, A₃, . . . Aₙ₋₁, Aₙ, Aₙ₊₁ . . . contained in the Guidelines Database 202 (FIG. 5).

The Apparel Database 204 also stores a listing of the apparel AP₁, AP₂, AP₃ . . . which is associated with the customized items contained in Personal Database 203. The apparel AP₁, AP₂, AP₃ . . . are stored in the Apparel Database 204 in accordance with the apparel pointers A₁, A₂, A₃, . . . Aₙ₋₁, Aₙ, Aₙ₊₁ . . . contained in the Personal Database 203 (FIG. 6).

It should be noted that any type of apparel may be contained within the Apparel Database 204. In addition, the apparel may be stored in the Apparel Database 204 at multiple levels with more than one type of description. As an example, boot cover, bootie, bootee and shoe cover may all be stored in the Apparel Database 204 singularly, or in some combination. Some other examples of apparel include gowns, face masks, gloves, visors, eye shields, respirators and draping systems.

An example of the Guidelines Database 202 is illustrated in FIG. 5. The Guidelines Database 202 includes data for guidelines (e.g., D, E and F) that may be required of the apparel which is used in surgical procedures. The Guidelines Database 202 also stores a listing of the guidelines GA₁, GA₂, GA₃ . . . which are associated with the apparel contained in the Apparel Database 204. These guidelines GA₁, GA₂, GA₃ . . . are stored in the Guidelines Database 202 in accordance with the guidelines pointers G₁, G₂, G₃ . . . Gₙ₋₁, Gₙ, Gₙ₊₁ . . . contained in the Apparel Database 204.

As discussed above, for each guideline, the Guidelines Database 202 includes (i) Apparel pointers A₁, A₂, A₃ . . . Aₙ₋₁, Aₙ, Aₙ₊₁ . . . which point into the Apparel Database 204. The Apparel pointers A₁, A₂, A₃, . . . Aₙ₋₁, Aₙ, Aₙ₊₁ . . . point into the Apparel Database 204 in order to designate the types of apparel which are associated with guidelines listed in the Guidelines Database 202.

It should be noted that any type of guideline may be contained within the Guidelines Database 201. In addition, the guidelines may be stored in the Guidelines Database 201 at multiple levels. As an example, broad standardized guidelines, such OSHA and AORN may be stored in the Guidelines Database 201.

In some forms, the Guidelines Database 202 may also store one or more specific guidelines, such as particular hospital guidelines, or even particular operating room guidelines. Some other example specific guidelines include operating room, catheterization lab, emergency room, central services, critical care and intensive care.

The product selection program 118 may also include the ability to identify a user such that only relevant specific guidelines are displayed to the user. As an example, if the product selection program 118 recognizes the user as being associated with a certain hospital, only specific guidelines associated with that hospital may be displayed to the user. In addition, the product selection program 118 may recognize the user as being involved in a particular field of surgery such that only guidelines for clinical studies related to that particular field may be displayed to the user.

An example of the Personal Database 203 is illustrated in FIG. 6. The Personal Database 203 stores a listing of customized items of apparel contained in the Apparel Database 204. These customized items PA₁, PA₂, PA₃ . . . are stored in the Personal Database 203 in accordance with the personal pointers P₁, P₂ . . . Pₙ₋₁, Pₙ, Pₙ₊₁ . . . contained in the Apparel Database 204.

As discussed above, for each customized item of apparel, the Personal Database 203 includes (i) Apparel pointers A₁, A₂, A₃ . . . Aₙ₋₁, Aₙ, Aₙ₊₁ . . . which point into the Apparel Database 204. The Apparel pointers A₁, A₂, A₃, . . . Aₙ₋₁, Aₙ, Aₙ₊₁ . . . point into the Apparel Database 204 in order to designate the types of apparel which are associated with customized items listed in the Personal Database 203.

It should be noted that any type of customized item may be contained within the Personal Database 203. In addition, multiple customized items may be stored in the Personal Database 203 for each apparel product. As an example, customized items for each apparel product may be organized within the Personal Database 203 by color and/or size. The apparel may be organized generally by size (e.g., S, M, L), and/or more specifically by size (e.g., 8 inch head size, 38 inch inseam). Some other examples of customized items for the apparel products include non-latex apparel products for individuals that are allergic to latex. In addition, the apparel may include a particular type of fastening system (e.g., buttons, Velcro and/or adhesives).

In some forms, customized items for each apparel product may be organized within the Personal Database 203 according to labels on the apparel (e.g., “Methodist Hospital” or “Dr. John Doe.” In addition, the customized items may be categorized by the job functions of the individuals that wear the apparel. Some examples include nurse, doctor, anesthesiologist and maintenance (among other job functions).

As shown in FIG. 7, when the product selection program 118 is entered by a user who wishes to select an apparel product for a surgical procedure, block 1002 of the apparel selection component 1000 is executed to display a prompt to the user to enter either the type of apparel that is desired, or the type of surgical procedure for which the apparel will be used.

When the user enters a type of apparel in response to the screen display presented by the block 1002, block 1004 is executed to display one or more of the following: (i) the surgical procedures where the apparel may be used; (ii) the guidelines that may be required for the apparel; and (iii) customized items of the apparel.

As an example, if the user enters apparel T in the screen display presented to the user by execution of block 1004, block 1006 accesses the apparel T in the Apparel Database 204 in order to determine the surgical procedures pointer S₁, the guidelines pointer G₁, and the personal pointer P₁ for apparel T.

Block 1006 then fetches the surgical procedures (and/or features) SA₁ from the Surgical Procedures Database 201 based upon surgical procedures pointer S₁ for apparel T in the Apparel Database 204, and stores the fetched surgical procedures SA₁ in temporary memory 1008. Block 1006 also fetches the guidelines GA₁ from the Guidelines Database 202 based upon the guidelines pointer G₁ for the apparel T in the Apparel Database 204, and stores the guidelines GA₁ in the temporary memory 1008. Block 1006 also fetches the customized items PA₁ from the Personal Database 203 based upon the personal pointer P₁ for the apparel T in the Apparel Database 204, and stores the fetched customized items PA₁ in the temporary memory 1008.

The apparel T entered as a result of the screen display (block 1004) may also be stored in the temporary memory 1008. Thereafter, block 1010 is executed to display the surgical procedures SA₁, the guidelines GA₁, the customized items PA₁, and the apparel T to the user. At block 1012 the user may select one of the following: (i) the displayed surgical procedures SA₁ where the apparel T will be used; (ii) the guidelines GA₁ that are required for the apparel T; and (iii) the customized items that are associated the apparel T.

When the user selects one of the surgical procedures (procedure X will be used as an example) where the apparel will be used, block 1018 accesses the surgical procedure in the Surgical Procedures Database 201 in order to determine the apparel pointers A₁. The block 1018 then fetches apparel AS₁ from the Apparel Database 204 based upon the apparel pointers A₁ in the Surgical Procedures Database 201, and stores the fetched apparel AS₁ in temporary memory 1022. Block 1024 then displays the fetched apparel AS₁ to the user. The user may select one or more of the displayed apparel in order to purchase the apparel or receive further information on the apparel.

In some forms, Block 1024 may permit the user to further filter the displayed apparel by (i) selecting a guideline and then fetching apparel AGₙ from the Apparel Database 204 based upon the apparel pointers Aₙ in the Guidelines Database 202; and/or (ii) selecting a customized item and then fetching apparel APₙ from the Apparel Database 204 based upon the apparel pointers Aₙ in the Personal Database 203. It should be noted that any apparel that is fetched from the Apparel Database 204 may be displayed to the user for purchase selection or to receive further information on the apparel.

When the user selects one of the guidelines for the apparel T, the block 1038 accesses the guideline in the Guideline Database 202 in order to determine one or more apparel pointers Aₙ. The block 1038 then fetches apparel AGₙ from the Apparel Database 204 based upon the apparel pointers Aₙ in the Guideline Database 202, and stores the fetched apparel AGₙ in temporary memory 1042. Block 1024 then displays the fetched apparel AGₙ to the user. The user may select one or more of the displayed apparel in order to purchase the apparel or receive further information on the apparel.

In some forms, Block 1024 may permit the user to further filter the displayed apparel by (i) selecting a surgical procedure and then fetching apparel ASₙ from the Apparel Database 204 based upon the apparel pointers Aₙ in the Surgical Procedures Database 201; and/or (ii) selecting a customized item of apparel and then fetching apparel APₙ from the Apparel Database 204 based upon the apparel pointers Aₙ in the Personal Database 203.

When the user selects a customized item for the apparel T, block 1058 accesses the customized item in the Personal Database 203 in order to determine one or more apparel pointers Aₙ. The block 1058 then fetches apparel APₙ from the Apparel Database 204 based upon the apparel pointers Aₙ, and stores the fetched apparel APₙ in temporary memory 1062. Block 1024 then displays the fetched apparel APₙ to the user. The user may select one or more of the displayed apparel in order to purchase the apparel or receive further information on the apparel.

In some forms, Block 1024 may permit the user to further filter the displayed apparel by (i) selecting a surgical procedure and then fetching apparel ASₙ from the Apparel Database 204 based upon the apparel pointers Aₙ in the Surgical Procedures Database 201; and/or (ii) selecting a guideline and then fetching apparel AGₙ from the Apparel Database 204 based upon the apparel pointers Aₙ in the Guidelines Database 202.

It should be noted the surgical procedures, guidelines, customized items and/or apparel may be selected by a user in any conventional manner. Some examples include typing information onto a keyboard and/or clicking onto internet links that are displayed to a user (among other examples).

FIG. 8 shows another form of the apparel selection component 2000. When the product selection program 118 is entered by a user, block 2002 is executed to display a prompt to the user to enter either the type of apparel desired, or the type of surgical procedure for which the apparel will be used. When the user enters the type of surgical procedure, block 2006 fetches the apparel that may be required for the surgical procedure.

As an example, if the user enters surgical procedure X in response to the screen display presented to the user by execution of the block 2002, the block 2006 accesses the surgical procedure X in the Surgical Procedures Database 201 in order to determine the apparel pointer A₁ which represents the surgical procedure X. The block 2006 then fetches the apparel AS₁ from the Apparel Database 204 based upon the apparel pointer A₁, and stores the fetched apparel AS₁ in temporary memory 2008.

The surgical procedure X entered as a result of the screen display is also stored in the temporary memory 2008. Thereafter, block 2010 displays the surgical procedure X and the fetched apparel AS₁ to the user.

In some forms, at block 2012 the user may further filter the displayed apparel by selecting (i) the guidelines that may be required for the displayed apparel; and/or (ii) customized items that relate to the displayed apparel.

When the user selects a guideline (e.g., D, E or F), block 2038 accesses the guideline in the Guideline Database 202 in order to determine one or more apparel pointers Aₙ. The block 2038 then fetches apparel AGₙ from the Apparel Database 204 based upon the apparel pointers Aₙ in the Guidelines Database 202, and stores the fetched apparel AGₙ in temporary memory 2042. Block 2024 then displays the fetched apparel AGₙ to the user. The user may select one or more of the displayed apparel in order to purchase the apparel or receive further information on the apparel

When the user selects a customized item, block 2018 accesses the customized item in the Personal Database 203 in order to determine one or more apparel pointers Aₙ. The block 2018 then fetches apparel APₙ from the Apparel Database 204 based upon the apparel pointers Aₙ and stores the fetched apparel APₙ in temporary memory 2022. Block 2024 then displays the fetched apparel APₙ to the user.

Accordingly, the present invention provides a set of interacting databases 201-204 which contain information on surgical procedures, guidelines, apparel and customized items associated with the apparel. The example apparel selection components 1000, 2000 that are illustrated in FIGS. 7 and 8 integrate with the databases 201-204 in order to provide a solution for selecting apparel products that are used in surgical procedures. Organizing the surgical procedures, guidelines, apparel and customized items that are associated with the apparel into databases allows the method and data processing system to be easily upgraded as the surgical procedures, guidelines, apparel and customized items change over time.

Certain modifications of the present invention have been discussed above. Other modifications will occur to those practicing in the art of the present invention. As an example, more or fewer databases may be used in the database component 200 of the product selection program 118.

In addition, examples of pointers which point from specific databases into other specific databases have been disclosed herein. It should be understood, however, that these pointers are illustrative, such that pointers may point from any of the databases disclosed herein to any of the other databases.

It should be noted that the Surgical Procedures Database 201, the Guidelines Database 202, the Personal Database 203, and the Apparel Database 204 disclosed herein are examples. These databases may contain more or different data than that shown.

The operations discussed above with respect to the described methods may be performed in a different order from those described herein. In addition, FIGS. 1-8 are representational and are not necessarily drawn to scale. Certain proportions thereof may be exaggerated, while others may be minimized.

While the invention has been described in detail with respect to the specific aspects thereof, it will be appreciated that those skilled in the art, upon attaining an understanding of the foregoing, may readily conceive of alterations to, variations of, and equivalents to these aspects which fall within the spirit and scope of the present invention, which should be assessed accordingly to that of the appended claims.

1. A method of selecting apparel products for surgical procedures, the method comprising:
executing program code in a data processing system in order to determine surgical procedures that are associated with a type of apparel;
selecting one of the surgical procedures; and
executing program code in the data processing system in order to determine apparel products that are associated with the selected surgical procedure.

2. The method of claim 1 further comprising selecting one of the apparel products for purchase.

3. The method of claim 1 further comprising selecting one of the apparel products to obtain information on the selected apparel product.

4. The method of claim 1 further comprising:
executing program code in the data processing system in order to determine guidelines that are associated with the apparel products; and
selecting one of the guidelines; and
executing program code in the data processing system in order to determine which of the apparel products are associated with the selected guideline.

5. The method of claim 1 further comprising:
executing program code in the data processing system in order to determine customized items that are associated with the apparel products;
selecting one of the customized items; and
executing program code in the data processing system in order to determine which of the apparel products are associated with the selected customized item.

6. A method of selecting apparel products for surgical procedures, the method comprising:
executing program code in a data processing system in order to determine guidelines that are associated with a type of apparel;
selecting one of the guidelines; and
executing program code in the data processing system in order to determine apparel products that are associated with the selected guideline.

7. The method of claim 6 further comprising selecting one of the apparel products for purchase.

8. The method of claim 6 further comprising selecting one of the apparel products to obtain information on the selected apparel product.

9. The method of claim 6 further comprising:
executing program code in a data processing system in order to determine surgical procedures that are associated with the apparel products;
selecting one of the surgical procedures; and
executing program code in the data processing system in order to determine which of the apparel products are associated with the selected surgical procedure.

10. The method of claim 6 further comprising:
executing program code in the data processing system in order to determine customized items that are associated with the apparel products;
selecting one of the customized items; and
executing program code in the data processing system in order to determine which of the apparel products are associated with the selected customized item.

11. A method of selecting apparel products for surgical procedures, the method comprising:
executing program code in the data processing system in order to determine customized items that are associated with a type of apparel;
selecting one of the customized items; and
executing program code in the data processing system in order to determine apparel products that are associated with the selected customized item.

12. The method of claim 11 further comprising selecting one of the apparel products for purchase.

13. The method of claim 11 further comprising selecting one of the apparel products to obtain information on the selected apparel product.

14. The method of claim 11 further comprising:
executing program code in a data processing system in order to determine surgical procedures that are associated with the apparel products;
selecting one of the surgical procedures; and
executing program code in the data processing system in order to determine which of the apparel products are associated with the selected surgical procedure.

15. The method of claim 11 further comprising:
executing program code in the data processing system in order to determine guidelines that are associated with the apparel products;
selecting one of the guidelines; and
executing program code in the data processing system in order to determine which of the apparel products are associated with the selected guideline.

16. A method of selecting apparel products for surgical procedures, the method comprising:
entering a surgical procedure into a data processing system; and
executing program code in a data processing system in order to determine apparel products that are associated with a surgical procedure; and
displaying the apparel products to a user.

17. The method of claim 16 further comprising selecting one of the apparel products for purchase.

18. The method of claim 16 further comprising selecting one of the apparel products to obtain information on the selected apparel product.

19. The method of claim 19 further comprising:
executing program code in the data processing system in order to determine guidelines associated with the apparel products;
selecting one of the guidelines; and
executing program code in the data processing system in order to determine which of the apparel products are associated with the selected guideline.

20. The method of claim 16 further comprising:
executing program code in the data processing system in order to determine customized items associated with the apparel products;
selecting one of the customized items; and
executing program code in the data processing system in order to determine which of the apparel products are associated with the selected customized item.

21. A data processing system comprising:
a computer readable storage medium; and
program code stored on the computer readable storage medium, wherein executing the program code includes determining surgical procedures that are associated with a type of apparel entered by a user, accepting one of the surgical procedures as selected by the user, and determining apparel products that are associated with the selected surgical procedure.

22. The data processing system of claim 21 wherein the program code includes an apparel database containing data on apparel and a surgical procedures database containing data on surgical procedures.

23. The data processing system of claim 21 wherein executing the program code includes determining guidelines that are associated with the apparel products, accepting a guideline as selected by the user, and determining which of the apparel products are associated with the selected guideline.

24. The data processing system of claim 21 wherein executing the program code includes determining customized items that are associated with the apparel products, accepting a customized item as selected by the user, and determining which of the apparel products are associated with the selected customized item.

25. A data processing system comprising:
a computer readable storage medium; and
program code stored on the computer readable storage medium, wherein executing the program code includes determining guidelines that are associated with a type of apparel entered by a user, accepting one of the guidelines as selected by the user, and determining apparel products that are associated with the selected guideline.

26. The data processing system of claim 25 wherein the program code includes an apparel database containing data on apparel and a guidelines database containing data on guidelines.

27. The data processing system of claim 25 wherein executing the program code includes determining surgical procedures that are associated with the apparel products, accepting a surgical procedure as selected by the user, and determining which of the apparel products are associated with the selected surgical procedure.

28. The data processing system of claim 25 wherein executing the program code includes determining customized items that are associated with the apparel products, accepting a customized item as selected by the user, and determining which of the apparel products are associated with the selected customized item.

29. A data processing system comprising:
a computer readable storage medium; and
program code stored on the computer readable storage medium, wherein executing the program code includes determining customized items that are associated with a type of apparel entered by a user, accepting one of the customized items as selected by the user, and determining apparel products that are associated with the selected customized item.

30. The data processing system of claim 29 wherein the program code includes an apparel database containing data on apparel and a personal database containing data on customized items.

31. The data processing system of claim 29 wherein executing the program code includes determining surgical procedures that are associated with the apparel products, accepting a surgical procedure as selected by the user, and determining which of the apparel products are associated with the selected surgical procedure.

32. The data processing system of claim 29 wherein executing the program code includes determining guidelines that are associated with the apparel products, accepting a guideline as selected by the user, and determining which of the apparel products are associated with the selected guideline.

33. A data processing system comprising:
a computer readable storage medium; and
program code stored on the computer readable storage medium, wherein executing the program code includes accepting a surgical procedure entered by a user, determining types of apparel that are associated with the surgical procedure entered by the user, accepting one type of apparel as selected by the user, and determining apparel products that are associated with the selected type of apparel.

34. The data processing system of claim 33 wherein the program code includes an apparel database containing data on apparel and a surgical procedures database containing data on surgical procedures.

35. The data processing system of claim 33 wherein executing the program code includes determining guidelines that are associated with the apparel products, accepting a guideline as selected by the user, and determining which of the apparel products are associated with the selected guideline.

36. The data processing system of claim 33 wherein executing the program code includes determining customized items that are associated with the apparel products, accepting a customized item as selected by the user, and determining which of the apparel products are associated with the selected customized item.

37. A method of selecting apparel products for surgical procedures, the method comprising:
executing program code in a data processing system in order to determine types of surgical procedures, guidelines and customized items that are associated with a type of apparel;
selecting a surgical procedure, guideline or customized item;
executing program code in the data processing system in order to determine apparel products that are associated with the selected surgical procedure, guideline or customized item;
selecting another of a surgical procedure, guideline or customized item that was not previously selected;
executing program code in the data processing system in order to determine apparel products that are associated with the selected another surgical procedure, guideline or customized item that was not previously selected;
selecting a remaining surgical procedure, guideline or customized item that was not previously selected; and
executing program code in the data processing system in order to determine apparel products that are associated with the selected remaining surgical procedure, guideline or customized item.

38. The method of claim 37 wherein the surgical procedure, the guideline and the customized item may be selected in any order.

39. A data processing system comprising:
a computer readable storage medium; and
program code stored on the computer readable storage medium, wherein executing the program code includes accepting a type of apparel entered by a user, determining surgical procedures, guidelines and customized items that are associated with the type of apparel entered by the user, selecting one of the surgical procedures, guidelines or customized items, and determining apparel products that are associated with the selected surgical procedure, guideline or customized item, selecting another of the surgical procedures, guidelines or customized items that was not previously selected, and determining apparel products that are associated with the selected another surgical procedure, guideline or customized item, selecting a remaining one of the surgical procedures, guidelines or customized items that was not previously selected, and determining apparel products that are associated with the selected remaining surgical procedure, guideline or customized item.

40. The data processing system of claim 39 wherein the program code includes an apparel database containing data on apparel, a surgical procedures database containing data on surgical procedures, a guidelines database containing data on guidelines and a personal database containing data on customized items.
